(19) United States
(12) Patent Application Publication
(10) Pub. No.: US 2015/0113034 A1
(43) Pub. Date: Apr. 23, 2015

(54) INFORMATION COMMUNICATION SYSTEM AND INFORMATION CONVERSION METHOD

(71) Applicants: Naotsugu Tome, Tokyo (JP); Takaaki Yayoi, Tokyo (JP)

(72) Inventors: Naotsugu Tome, Tokyo (JP); Takaaki Yayoi, Tokyo (JP)

(21) Appl. No.: 14/402,359

(22) PCT Filed: May 21, 2012
(86) PCT No.: PCT/JP2012/062971

§ 371 Date: Nov. 20, 2014

(51) Int. Cl. H04L 29/08; G06F 17/30

(52) U.S. Cl. CPC H04L 67/10; G06F 17/3089
USPC 709/201

(57) ABSTRACT

When receiving a conversion request from a smart device, an information conversion unit located at a Web server or the smart device refers to application activating information based on a transition destination of a first link included in a PC-specific Web page and specifies a smart-device-specific application which matches the transition destination of the first link; and on condition that an OS and version of the smart-device-specific application match an OS and version of the smart device, the information conversion unit converts the first link into a second link including an activation path in the application activating information and the smart device displays the second link, which has been converted by the information conversion unit, on the smart-device-specific Web page.

### TECHNICAL FIELD

The present invention relates to: an information communication system having an information conversion function that converts information managed by a Web server into information, to which a smart device refers to; and an information conversion method.

### BACKGROUND ART

A Web server that manages information disclosed on networks such as the Internet displays Web pages created for PCs (Personal Computers); and when a link for displaying a map in a Web page is clicked, the map can be displayed in the Web page. When this happens and if the link in a PC-specific Web page is accessed from a device such as a PC, the map can be displayed in the PC-specific Web page. However, if the link in the PC-specific Web page is accessed from a smart device, it is necessary to change the Web page, which is created for PCs, to a smart-device-specific Web page.

Specifically speaking, applications which are managed by the Web server are configured on the premise that they are used by a Web browser for a PC. So, if existing applications for the Web server are applied to a browser for the smart device, operability will decrease. Specifically speaking, the content of the Web page does not fit in a small screen of the smart device, buttons and links are small, and it is thereby difficult to perform touch operation. Therefore, association between applications for the Web server and applications for the smart device is required in order to enhance the operability and functionability.

Under this circumstance, a Web page provider rewrites a link in a PC-specific Web page in order to activate applications for a smart device by using an URL (Uniform Resource Locator) extension function for an OS (Operating System) and browser of the smart device. For example, descriptions of links included in a PC-specific Web page are rewritten to descriptions of links for activating the applications for the smart device.

Specifically speaking, when the Web page provider rewrites links in a PC-specific Web page, they extract all the links included in the PC-specific Web page, convert a URL path for the extracted links to a path for activating the applications for the smart device, and convert parameters of the links included in the PC-specific Web page into activation parameters to be delivered to the applications for the smart device.

Furthermore, if the applications for the smart device are in-house applications, the in-house applications are disclosed by, for example, the Web server and a mobile device management system and a user who has the smart device is requested to install and set the disclosed in-house applications. In this case, the user who uses the smart device will have to perform operations to install and set the disclosed in-house applications.

Furthermore, if the applications for the smart device are not installed as standard applications in the smart device and are generally available applications, it is necessary to request the user, who uses the smart device, to install the applications for the smart device. In this case, the Web page provider will request the user, who uses the smart device, to install and set the applications for the smart device. In this case, the user who uses the smart device will perform the operations to install and set the applications in accordance with the request from the Web page provider.

Meanwhile, for example, a markup language document conversion system for analyzing a block structure of a PC-specific HTML (Hypertext Markup Language), relocating each block so that a small screen can be displayed, and converting the relocated blocks into a mobile-specific HTML is suggested as a technique to create portable-device-specific pages from PC-specific Web pages (see Patent Literature 1). Also, a Web content conversion method and Web content conversion system for analyzing PC-specific sites, extracting subpages from each block of the HTML, and generating a reduced image of the entire HTML page and a top page having a link list based on the extracted subpages are suggested (see Patent Literature 2).

### CITATION LIST

### Patent Literature

[Patent Literature 1] Japanese Patent Application Laid-Open (Kokai) Publication No. 2009-1761444
[Patent Literature 2] Japanese Patent Application Laid-Open (Kokai) Publication No. 2006-243829

### SUMMARY OF INVENTION

### Problems to be Solved by the Invention

Since the conventional technology does not manage the relationship between PC-specific Web pages and applications for a smart device, there are problems as described below.

Specifically speaking, conversion of a Web page based on the block structure cannot generate a Web page for activating the applications for the smart device. Therefore, the Web page provider has to perform the operation to rewrite links included in a PC-specific Web page. Furthermore, if the applications for the smart device are not installed in the OS of the smart device, the applications for the smart device cannot be activated unless the user of the smart device install the applications for the smart device into the smart device in advance. If the applications for the smart device are in-house applications under this circumstance, the Web page provider needs to distribute the in-house applications and request the user to install the in-house applications. In this case, the advantage of the Web applications which can be used without installing the applications for the smart devices into the smart device will diminish.

Furthermore, a version of a smart-device-specific application is changed, the Web page provider has to repeat the operations to deal with the smart device according to the change of the application. Examples of changes of the application include changes or elimination of the smart-device-specific application, addition of an OS in which the smart-device-specific application is to be activated, and changes of an activation parameter in association with changes of specifications of the smart-device-specific application.

The present invention was devised in light of the above-mentioned problems of the conventional technology and it is the object of the present invention to provide an information communication system and information conversion method capable of automatically converting a link included in a Web page for a Web server into a link including an activation path for activating a smart-device-specific application.

### Means for Solving the Problems

In order to solve the above-described problems, the present invention provides an information communication system including an information conversion unit, which is located at either a Web server or a smart device, for converting information of a PC-specific Web page managed by the Web server into information of a smart-device-specific Web page to which the smart device refers; wherein the information conversion unit retains application activating information, which manages a transition destination of a first link included in the PC-specific Web page and a smart-device-specific application by associating them with each other and includes reference information used when activating the smart-device-specific application; when receiving a conversion request from the smart device, the information conversion unit refers to the application activating information based on the transition destination of the first link included in the PC-specific Web page and specifies a smart-device-specific application which matches the transition destination of the first link; and on condition that an operating system and version of the smart-device-specific application match an operating system and version of the smart device, the information conversion unit executes link conversion processing for converting the first link into a second link including an activation path in the application activating information and converting information of the converted second link into information of a language for the smart device; and wherein the smart device displays the second link, which has been converted by the information conversion unit, on the smart-device-specific Web page.

### Advantageous Effects of Invention

According to the present invention, a link included in a Web page for a Web server can be automatically converted into a link including an activation path for activating an application for a smart device.

### BRIEF DESCRIPTION OF DRAWINGS

FIG. 1 is a configuration diagram of an information communication system according to a first embodiment.

FIG. 2 is a configuration diagram of application activating information.

FIG. 3 is a configuration diagram of activation parameter conversion information.

FIG. 4 is a configuration diagram of an application activating information edit screen.

FIG. 5 is a configuration diagram of a parameter conversion rule edit screen.

FIG. 6 is a flowchart explaining a link conversion procedure.

FIG. 7 is a flowchart explaining a URL conversion procedure.

FIG. 8 is a configuration diagram of a link, which is converted according to the URL conversion procedure, before and after the conversion.

FIG. 9 is a flowchart explaining an application activation procedure.

FIG. 10 is a configuration diagram for explaining a display example of a Web page for a smart device.

FIG. 11 is a configuration diagram of a link including an embedded object example before and after the conversion.

FIG. 12 is a configuration diagram for explaining a display example of a PC-specific Web page and smart-device-specific Web page which use a link including an embedded object.

FIG. 13 is a configuration diagram of an information communication system according to a second embodiment.

FIG. 14 is a configuration diagram of an application activating information file.

FIG. 15 is a configuration diagram of an activation parameter conversion information file.

FIG. 16 is a configuration diagram of an information communication system according to a third embodiment.

FIG. 17 is a configuration diagram of an MDM system.

FIG. 18 is a configuration diagram of application management information.

FIG. 19 is a configuration diagram of device management information.

FIG. 20 is a configuration diagram of application activating information.

FIG. 21 is a flowchart for explaining a URL conversion procedure.

FIG. 22 is a configuration diagram of a link, which is converted according to the URL conversion procedure, before and after the conversion.

FIG. 23 is a flowchart for explaining an application activation procedure.

### MODE FOR CARRYING OUT THE INVENTION

### First Embodiment

A first embodiment of the present invention will be explained below with reference to the relevant drawings. This embodiment is an example of a system for converting Web applications into applications for a smart device.

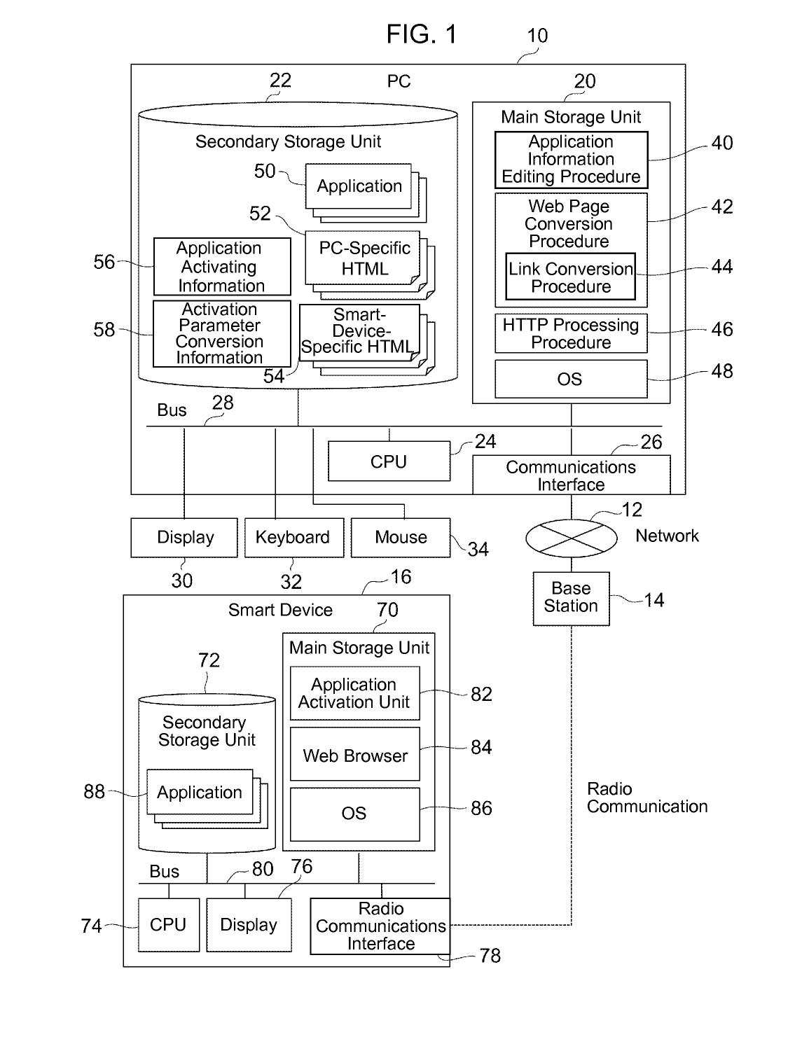

FIG. 1 is an overall configuration diagram of an information communication system according to the present invention. Referring to FIG. 1, the information communication system includes a Web server 10, a network 12, a base station 14, and a smart device 16; and the Web server 10 is connected via the network 12 to the base station 14. The base station 14 sends and receives information to and from the Web server 10 via the network 12 and sends and receives information to and from the smart device 16 via radio communications.

The Web server 10 includes a main storage unit 20, a secondary storage unit 22, a CPU 24, a communications interface 26, a bus 28, a display 30, a keyboard 32, and a mouse 34; and the main storage unit 20, the secondary storage unit 22, the CPU 24, the communications interface 26, the display 30, the keyboard 32, are the mouse 34 are connected to each other via a bus 28.

The main storage unit 20 stores, as various programs, an application information editing procedure 40, a Web page conversion procedure 42, a link conversion procedure 44, and an HTTP (Hypertext Transfer Protocol) processing procedure 46 as well as an OS 48 for activating the various programs.

The secondary storage unit 22 stores a plurality of applications 50 to be distributed to the smart device 16, PC-specific HTML 52, smart-device-specific HTML 54, application activating information 56, and activation parameter conversion information 58.

The CPU 24 functions as a control unit for supervising and controlling the entire Web server 10, also functions as an information processing unit for processing, for example, programs in the main storage unit 20 and information in the secondary storage unit 22 based on information from the display 30, the keyboard 32, and the mouse 34, and further functions as an information conversion unit for converting information of a PC-specific Web page into information to which the smart device 16 refers.

The communications interface 26 connects the CPU 24 to the network 12 and functions as an interface for connecting the CPU 24 and the base station 14. The display 30 functions as a display unit for displaying various information and the keyboard 32 and the mouse 34 function as input units for inputting various information.

The application information editing procedure 40 is a program for editing the application activating information 56 and the activation parameter conversion information 58 and providing the edited image information on a screen of the display 30.

The Web page conversion procedure 42 is a program for converting the PC-specific HTML 52, which is information included in a Web page, into information of a language for the smart device, for example, the smart-device-specific HTML 54.

The link conversion procedure 44 is a program for executing link conversion processing for converting a transition destination URL of a link (first link) included in a Web page into a link (second link) including an activation path for activating an application 88.

The HTTP processing procedure 46 is a program for processing a protocol used when sending and receiving information such as files sent and received between the Web server 10 and a Web browser 84 for the smart device 16, and for executing processing for sending the smart-device-specific HTML 54, which is converted to the smart-device-specific HTML, to the Web browser 84 for the smart device 16.

The smart device 16 includes a main storage unit 70, a secondary storage unit 72, a CPU 74, a display 76, a radio communication interface 78, and a bus 80; and the main storage unit 70, the secondary storage unit 72, the CPU 74, the display 76, and the radio communication interface 78 are connected to each other via a bus 80.

The main storage unit 70 stores, as various programs, an application activation unit 82 and the Web browser 84 for accessing the Web server 10, as well as an OS 86 for activating the various programs.

The secondary storage unit 72 stores a plurality of smart device applications 88, which are activated by the application activation unit 82.

The CPU 74 functions as a control unit for supervising and controlling the entire smart device 16 and also functions as an information processing unit for executing processing of programs stored in the main storage unit 70 and the applications stored in the secondary storage unit 72. The display 76 functions as a display unit for displaying smart-device-specific Web pages.

The radio communication interface 78 functions as an interface used when the CPU 74 performs radio communications with the base station 14.

The application activation unit 82 is a program for acquiring the applications 50 stored in the secondary storage unit 22 for the Web server 10, installs the acquired applications 50 as the smart-device-specific applications 88 into the secondary storage unit 72, and activating the applications 88 stored in the secondary storage unit 72.

The Web browser 84 is a program for accessing Web pages of the Web server 10.

The following processing will be executed here according to this embodiment.

(1) A Web page provider inputs the application activating information 56 and the activation parameter conversion information 58 by using an application information edit screen and a parameter conversion rule edit screen which are displayed on a screen of the display 30.

(2) Next, a Web page user such as a user who uses the smart device 16 invokes the HTTP processing procedure 46 of the Web server 10 by using the Web browser 84 for the smart device 16.

(3) The HTTP processing procedure 46 invokes the Web page conversion procedure 42 by issuing a conversion request.

(4) The Web page conversion procedure 42 converts a Web page composed of the PC-specific HTML 52 into a Web page composed of the smart-device-specific HTML 54 based on the conversion request.

(5) The Web page conversion procedure 42 invokes the link conversion procedure 44 and converts a link included in the smart-device-specific HTML 54 into a link including an activation path for activating the applications 88.

(6) The HTTP processing procedure 46 sends the link, which is composed of the smart-device-specific HTML converted by the link conversion procedure 44, to the Web browser 84 for the smart device 16.

(7) The Web browser 84 displays the link composed of the smart-device-specific HTML on the display 76.

(8) The Web page user which is a user of the smart device 16 clicks the link in the Web page displayed on the display 76.

(9) The Web browser 84 invokes the application activation unit 82 in response to click operation on the link and the application activation unit 82 activates the applications 88.

Step (1) of the above procedure may be executed once by the Web page provider; and every time the Web page user uses a Web page, the procedure in step (2) and subsequent steps are executed repeatedly.

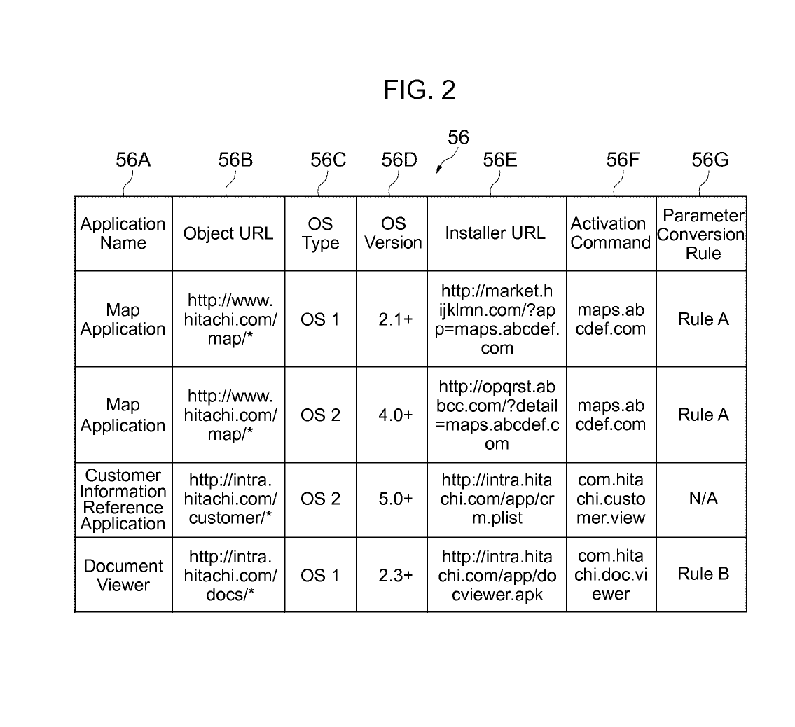

FIG. 2 is a configuration diagram of the application activating information. Referring to FIG. 2, the application activating information 56 is information, which is stored in the secondary storage unit 22 and is managed by the Web server 10, and is constituted from: an application name 56A for specifying the relevant application 88; an object URL 56B which is information for identifying the relevant Web page; an OS type 56C; an OS version 56D; an installer URL 56E; an activation command 56F; and a parameter conversion rule 56G. The OS type 56C, the OS version 56D, the installer URL 56E, the activation command 56F, and the parameter conversion rule 56G are configured as reference information which is necessary for the application activation unit 82 to activate the application 88.

For example, if the application 50 is an application for displaying a map, the application name 56A stores information indicating “Map Application.”

For example, if the link information included in the Web page is a map, the object URL 56B stores “/map/*.” Incidentally, the object URL 56B indicates a URL condition for activating the relevant application 50 and the link which meets this condition will be converted into a link for activating the application. Furthermore, an asterisk sign included in the object URL 56B indicates an arbitrary character string. Specifically speaking, the link information described before the asterisk sign is information for specifying the link.

The OS type 56C is information for specifying the type of the OS used by the application 50. The OS version 56D is information for specifying the version of the OS used by the application 50.

If no application 88 exists in the secondary storage unit 72 for the smart device 16, the installer URL 56E is a URL for acquiring an application 80. Incidentally, for example, if an URL on the Internet where the application 50 is distributed is to be used, a URL of a binary package for installation of that application can be used as the installer URL 56E. If the application 50 is a generally available application, the former URL is used; and if the application is distributed within a limited range, for example, inside a company, the latter URL is used.

The activation command 56F is a command for activating the application 88. The parameter conversion rule 56G is information for specifying a rule to convert a parameter (pre-conversion parameter) included in the link in the PC-specific Web page into a parameter (converted parameter) used for activating the application 88.

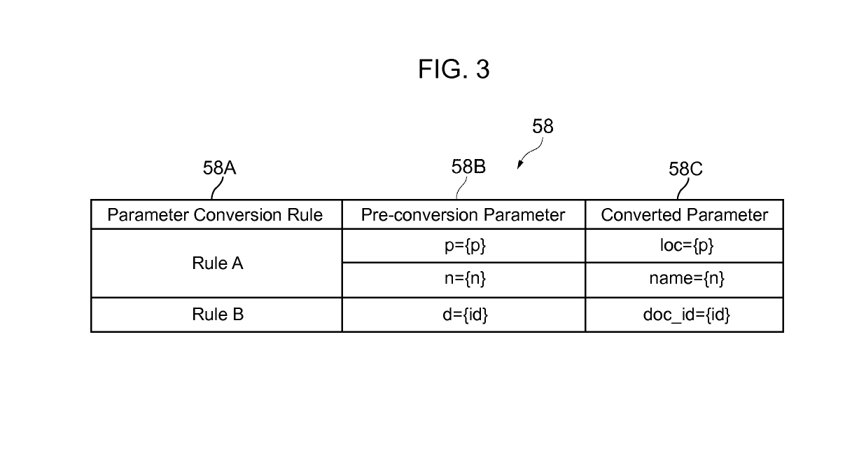

FIG. 3 is a configuration diagram of the activation parameter conversion information. Referring to FIG. 3, the activation parameter conversion information 58 is information stored in the secondary storage unit 22 for managing the parameter conversion rule 56G of the application activating information 56; and is constituted from a parameter conversion rule 58A, a pre-conversion parameter 58B, and a converted parameter 58C.

The parameter conversion rule 58A is the same information as the parameter conversion rule 56G of the application activating information 56. The pre-conversion parameter 58B is a parameter of the link included in the PC-specific Web page and is information for specifying a pre-conversion parameter. The converted parameter 58C is a parameter for activating the application 88 and is information for specifying a converted parameter.

In this example, if the parameter conversion rule 58A stores “rule B,” the pre-conversion parameter 58B stores “d={id},” and the converted parameter 58C stores “doc_id={id},” the pre-conversion parameter shows that parameter d will be converted and its value will be an indefinite number id. The converted parameter 58C shows that the conversion parameter d will be converted to parameter doc_id and the value of the indefinite number id will be used as a value of the converted parameter.

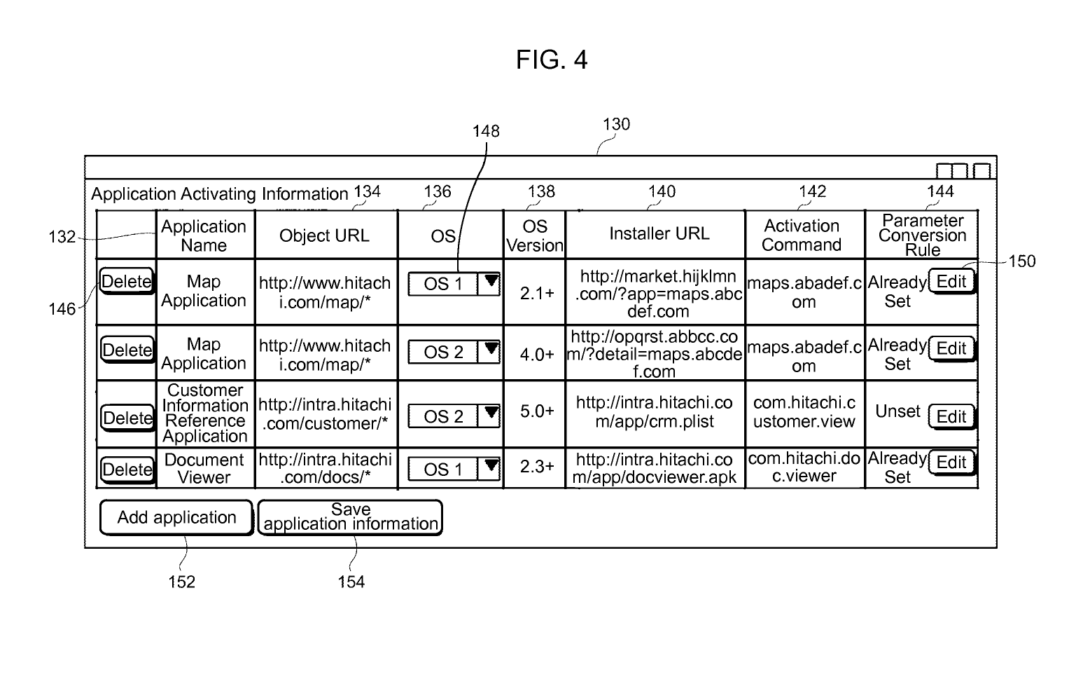

FIG. 4 is a configuration diagram of an application activating information edit screen. Referring to FIG. 4, an application activating information edit screen 130 is a screen used by the Web page provider to create or edit the application activating information 56. This application activating information edit screen 130 is constituted from an application name 132, an object URL 134, an OS 136, an OS version 138, an installer URL 140, an activation command 142, and a parameter conversion rule 144; and items from the application name 132 to the activation command 142 are configured as items whose values are input by the Web page provider. The parameter conversion rule 144 is an item to set whether the rule is set or not. When the rule is set, the parameter conversion rule 144 displays “Already Set”; and when the rule is not set, the parameter conversion rule 144 displays “Unset.”

Furthermore, a button 146 for deleting the relevant application, a selection button 148 for selecting the OS 106, and a button 150 for editing the parameter conversion rule are displayed in each row of the application activating information. When it becomes necessary to add an application after information which has been input by the Web page provider is displayed in each row, the application is added to the application activating information edit screen 130 by operating a button 152 indicating “Add Application”; and the application activating information 56 is saved in the secondary storage unit 22 by operating a button 154 indicating “Save Application Activating Information.” Furthermore, if the edit button 150 is operated, a parameter conversion rule edit screen will be opened.

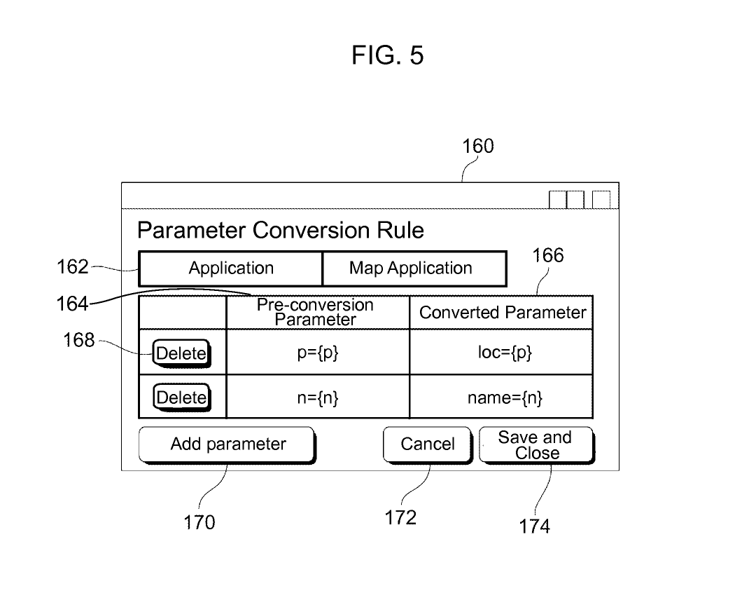

FIG. 5 is a configuration diagram of the parameter conversion rule edit screen. Referring to FIG. 5, a parameter conversion rule edit screen 160 is a screen for setting or editing the parameter conversion rule and is constituted from an application 162, a pre-conversion parameter 164, and a converted parameter 166. The application 162 displays a name of an application designated by the edit button 150 of the application activating information edit screen 130. The pre-conversion parameter 164 displays information stored in the pre-conversion parameter 58B of the activation parameter conversion information 58 and the converted parameter 166 displays information stored in the converted parameter 58C of the activation parameter conversion information 58.

The information displayed in the pre-conversion parameter 164 and the converted parameter 166 is deleted by operating a button 168. Furthermore, when adding parameters to the pre-conversion parameter 164 and the converted parameter 166, the content of these parameters is added by operating a button 170 indicating “Add Parameter.” Moreover, when canceling the operated content, it can be canceled by operating a cancel button 172. Furthermore, the information displayed on the parameter conversion rule edit screen 160 can be saved in the secondary storage unit 22 by operating a button 174 indicating “Save and Close.”

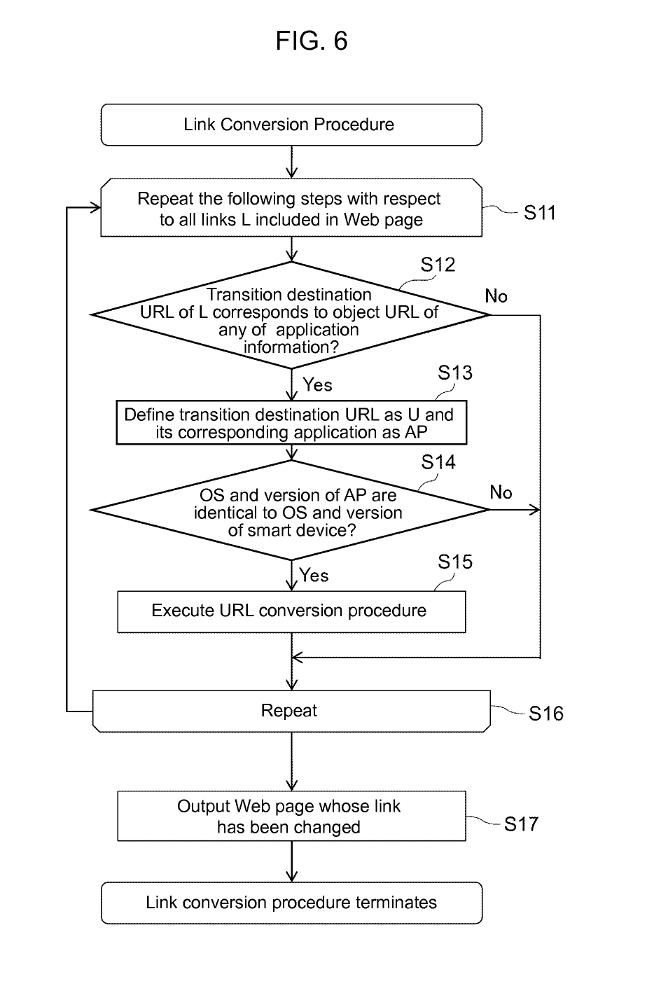

FIG. 6 is a flowchart for explaining processing of the link conversion procedure. This processing is started by activation of the link conversion procedure 44 by the CPU 24. The CPU 24 firstly repeats processing from step S11 to step S16 on all links L included in a Web page. The link(s) L herein used indicates association to jump from a certain Web page to another Web page.

The CPU 24 judges whether the transition destination URL of the link L corresponds to any of objects URL in the application activating information 56 (S12). If the CPU 24 obtains a negative judgment result in step S12, the CPU 24 proceeds to processing of step S16. If the CPU 24 obtains an affirmative judgment result in step S12, it defines the transition destination URL of the link L as U and its corresponding application as AP (S13). For example, if the link L is composed of an object URL and a parameter string and the object URL of this link L corresponds to an object URL of the application activating information 56, it defines the transition destination URL of this link L as U and an application where the object URL exists, such as “Map Application,” as AP.

Next, the CPU 24 judges whether an OS and version of the application AP are identical to the OS 86 and version of the smart device 16 or not (S14).

Under this circumstance, the CPU 24 executes processing of step S14 by using a value of a user-agent header included in an HTTP request from the smart device 16. Specifically speaking, the value of the user-agent header includes not only the type of the Web browser 84, but also information about the OS 86 and model of the smart device 16, so such information is used.

If the CPU 24 obtains a negative judgment result in step S14, the CPU 24 proceeds to processing of step S16; and if the CPU 24 obtains an affirmative judgment result in step S14, it executes the URL conversion procedure (S15). Subsequently, the CPU 24 repeats the processing from step S11 to step S16 until the processing of all links is completed.

Then, the CPU 24 outputs the Web page, whose link(s) has been changed (S17), and then terminates the processing in this routine.

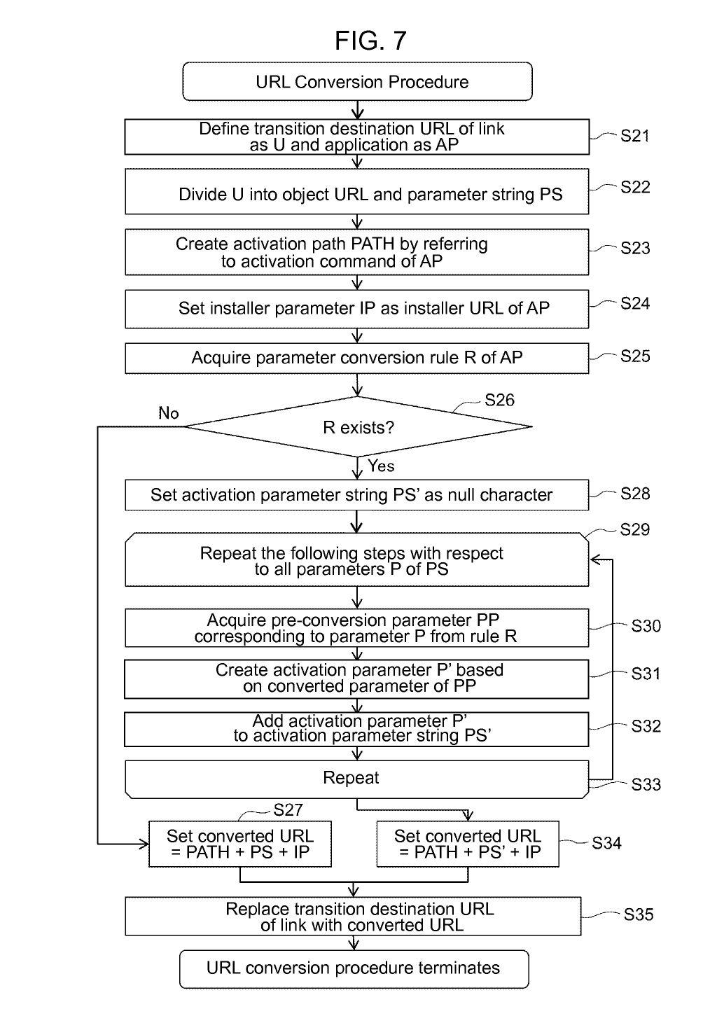

FIG. 7 is a flowchart for explaining processing of the URL conversion procedure. This processing is started by the CPU 24 as it activates a program (not shown) of the URL conversion procedure stored in the main storage unit 20.

The CPU 24 defines a transition destination URL of a link as U and an application as AP (S21).

Next, the CPU 24 divides U into an object URL and a parameter string PS (S22). For example, the CPU 24 divides the transition destination URL of the link (a href=), which is included in the Web page, into the object URL (/map/) and the parameter string PS (p=35.403 . . . ).

Then, if the CPU 24 selects, for example, “Map Application” as the application AP, it refers to the activation command 56F of the application AP corresponding to “Map Application” in the application activating information 56 and creates an activation path PATH (=callapp://+activation command+/) (S23).

Subsequently, the CPU 24 refers to the installer URL 56E of the application AP in the application activating information 56 and sets an installer parameter IP (=&installer=installer URL) as the installer URL of the application AP (S24).

Next, the CPU 24 refers to the parameter conversion rule 56G of the application AP and acquires a parameter conversion rule R from the parameter conversion rule 56G (S25).

Then, the CPU 24 judges whether, for example, “Rule A” exists as the parameter conversion rule R in the parameter conversion rule 56G or not (S26).

If the CPU 24 obtains a negative judgment result in step S26, the CPU 24 sets a converted URL=activation path PATH+parameter string PS+installer parameter IP (S27) and proceeds to processing of step S35.

On the other hand, if the CPU 24 obtains an affirmative judgment result in step S26, the CPU 24 sets an initial value of an activation parameter string PS′ by setting the activation parameter string PS′ as a null character (S28).

Next, the CPU 24 repeats processing from step S29 to step S33 on all parameters P for the parameter string PS. The parameter herein used is a parameter registered in the pre-conversion parameter 58B of the activation parameter conversion information 58; and, for example, if “Rule A” is used as the parameter conversion rule 58A, p and n are selected as the pre-conversion parameter 58B. Furthermore, the parameter string is a connection of p and n.

Then, the CPU 24 acquires a pre-conversion parameter PP corresponding to the parameter P from the parameter conversion rule A (S30). For example, the CPU 24 acquires p as the pre-conversion parameter PP from the pre-conversion parameter 58B.

Subsequently, the CPU 24 creates an activation parameter P′ based on the converted parameter 58C of the pre-conversion parameter PP (S31). For example, the CPU 24 selects loc as the activation parameter P′ from the pre-conversion parameter PP.

Next, the CPU 24 adds the created activation parameter P′ to the activation parameter string PS′ (S32).

Subsequently, the CPU 24 repeats the processing from step S29 to step S33, selects n from the pre-conversion parameter 58B, selects name as the activation parameter P′ from the converted parameter 58B, and adds the selected activation parameter P′ to the activation parameter string PS′.

Then, the CPU 24 sets a converted URL=activation path PATH+sign parameter string PS′+installer parameter IP (S34).

Next, the CPU 24 replaces a transition destination URL of a link destination with the converted URL created in step S27 or step S34 (S35), and then terminates the processing in this routine.

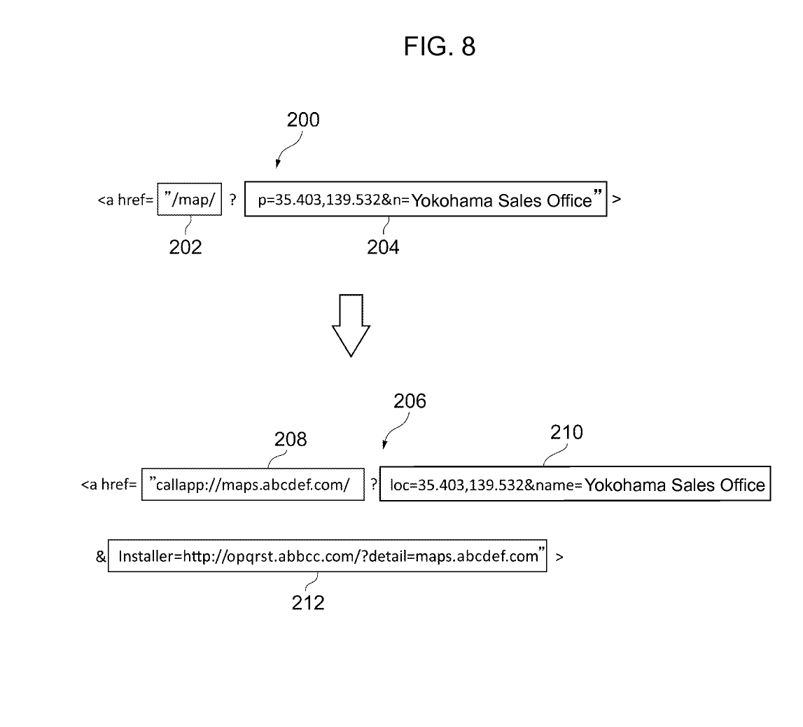

FIG. 8 is a configuration diagram showing a conversion example by the URL conversion procedure. Referring to FIG. 8, a pre-conversion link 200 is composed of an object URL 202 and a parameter string 204. On the other hand, a converted link 206 is composed of an activation path 208, an activation parameter string 210, and an installer URL 212.

In this example, a URL schema “callapp:” included in the activation path 208 is a schema for invoking the application activation unit 82 for the smart device 16. The OS 86 and the Web browser 84 of the smart device 16 have a function that is called a URL extension function. So, if the user clicks a link in a Web page, the corresponding application 88 can be activated with respect to a URL pattern of the clicked link. In this case, in order to utilize the URL extension function, the application 88 corresponding to the URL pattern needs to be registered in the OS 86 in advance.

Under this circumstance, according to this embodiment, a schema for invoking the application activation unit 82 is stored in the OS 86 in advance in order to activate the application activation unit 82 in accordance with the URL schema “callapp:.”

When the link whose URL is converted into the URL schema by the URL conversion procedure is clicked on the Web page on the Web browser 84, it functions as a link for activating the application activation unit 82 by means of the URL extension function.

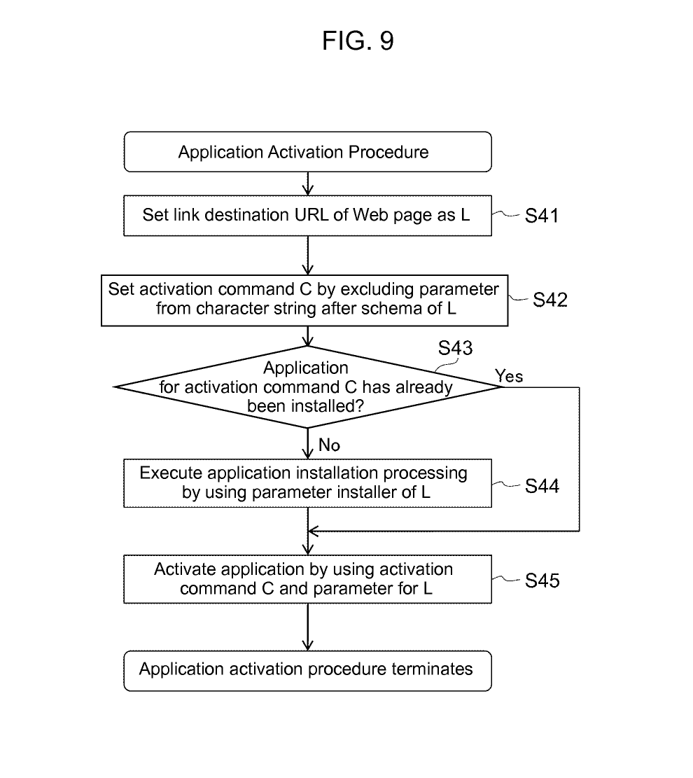

FIG. 9 is a flowchart for explaining the application activation procedure. This processing is started by the CPU 74 as it activates a program (not shown) indicating the application activation procedure stored in the main storage unit 70. This processing is to activate the application 88 by using an activation command included in the activation path of URL. Under this circumstance, if that application 88 is not installed, the application 88 is installed by using the installer URL designated by a parameter installer.

Specifically speaking, the CPU 74 defines the link destination URL of the Web page as L (S41) and sets an activation command C by excluding the parameter from the character string after the schema of L (S42).

Next, the CPU 74 judges whether the application 88 corresponding to the activation command C has been installed or not (S43).

If the CPU 24 obtains an affirmative judgment result in step S43, the CPU 74 proceeds to processing of step S45; and if the CPU 24 obtains a negative judgment result in step S43, the CPU 24 executes processing for installing the application 88 by using the parameter installer for L (S44).

Then, the CPU 74 activates an application which had been installed or the installed application 88 by using the command C and the parameter for L (however, excluding the installer) (S44), and then terminates the processing in this routine.

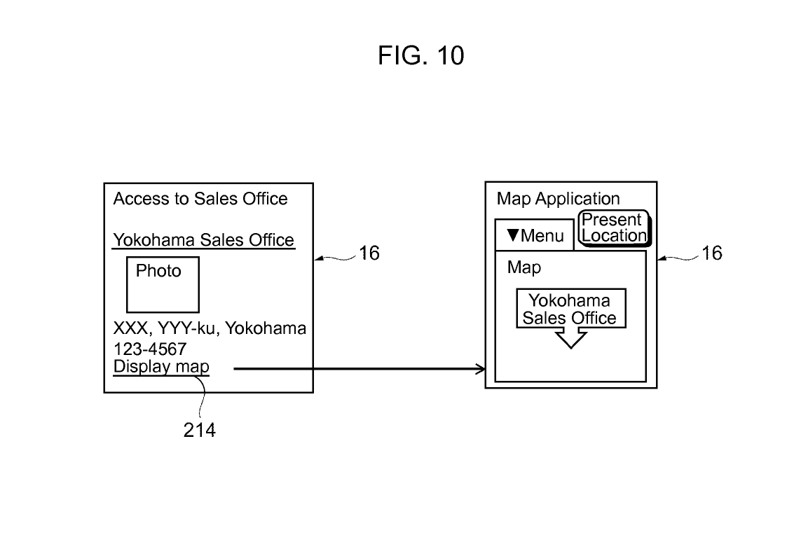

FIG. 10 is a configuration diagram showing a display example of the smart device. Referring to FIG. 10, when a link 214 for activating an application “Map Application” is displayed on the display 76 of the smart device 16 and the link 214 is clicked, the application activation unit 82 activates the application 88 based on the converted link 206. As a result, a map is displayed on the display 76 of the smart device 16.

According to this embodiment, a link included in a PC-specific Web page (first link) can be automatically converted to a link including an activation path for activating a smart-device-specific application (second link). Therefore, when the link 214 for activating the application 88 “Map Application” is displayed on the display 76 of the smart device 16 and this link 214 is clicked, the application 88 can be activated and a map can be displayed on the display 76.

### Variation Example

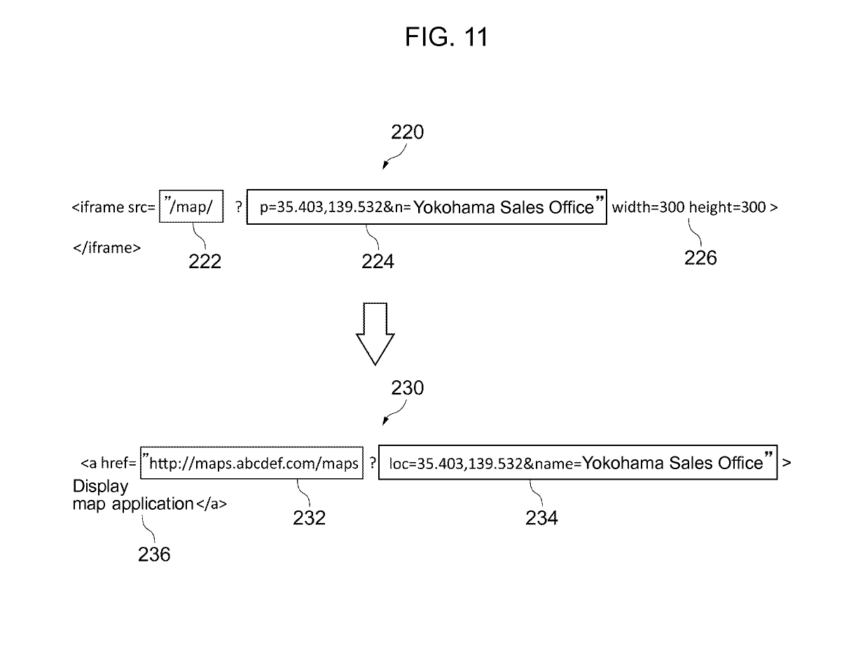

FIG. 11 is a configuration diagram for explaining a variation example of a link in which an embedded object is added to a PC-specific Web page. Referring to FIG. 11, a link 220 in which an embedded object is added to a PC-specific Web page is composed of an object URL 220, a parameter string 224, and an embedded object 226. A link 230 is obtained by converting the link 220 into a link in a smart-device-specific Web page and is composed of an activation path 232, an activation parameter string 234, and a display tag 236. The display tag 236 is a tag obtained by converting the embedded object 226 and is configured as a tag which serves as an operation object for activating the application 88.

Under this circumstance, in addition to processing of all links, the link conversion procedure 44 also executes URL conversion processing on link destinations U of all embedded objects 226. In this case, the URL conversion procedure not only converts the transition destination URL of the link 220 including the embedded object 226, but also converts the embedded object 226 into the display tag 236.

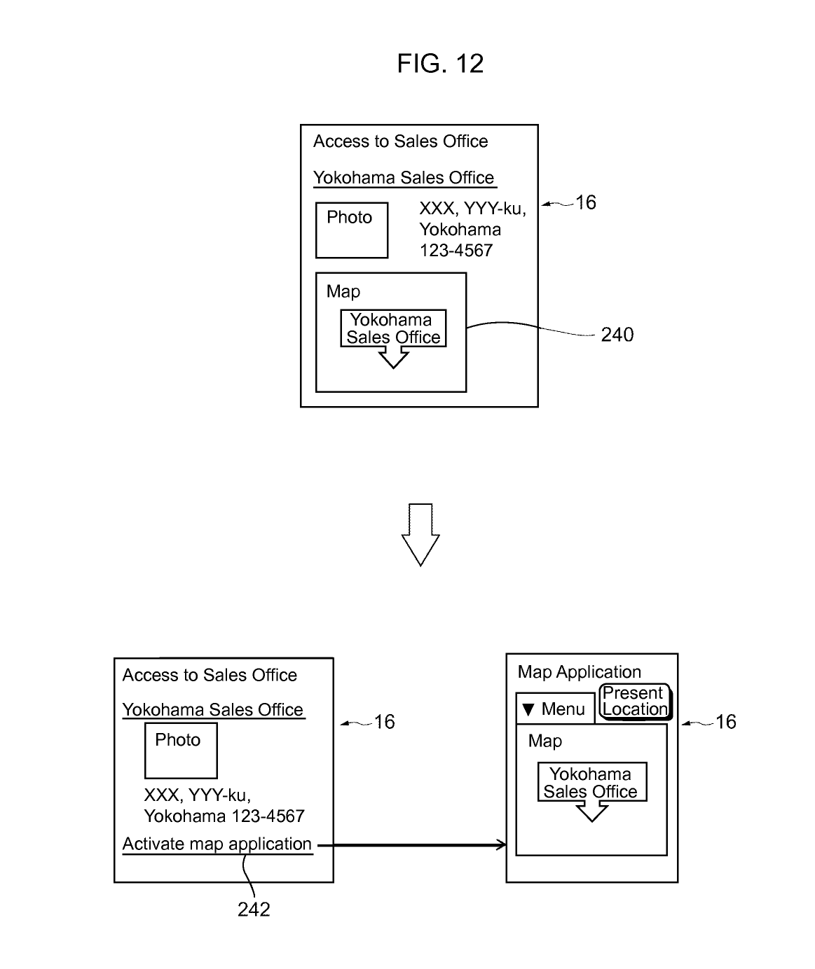

FIG. 12 is a configuration diagram showing a display example in which an embedded object is displayed in a PC-specific Web page. Referring to FIG. 12, when a link 240 including an embedded object 226 is displayed on the display 76 of the smart device 16 in accordance with the map application and if the link 220 is converted into a link 230 by means of the link conversion procedure 44, a link 242 including information of a display tag 236 is displayed on the display 76 of the smart device 16. Then, if the link 242 is clicked, a map is displayed on the display 76 of the smart device 16 in accordance with the map application.

According to the variation example, information of the application to be displayed can be displayed on the display 76 as the link 240 including the embedded object 226.

### Second Embodiment

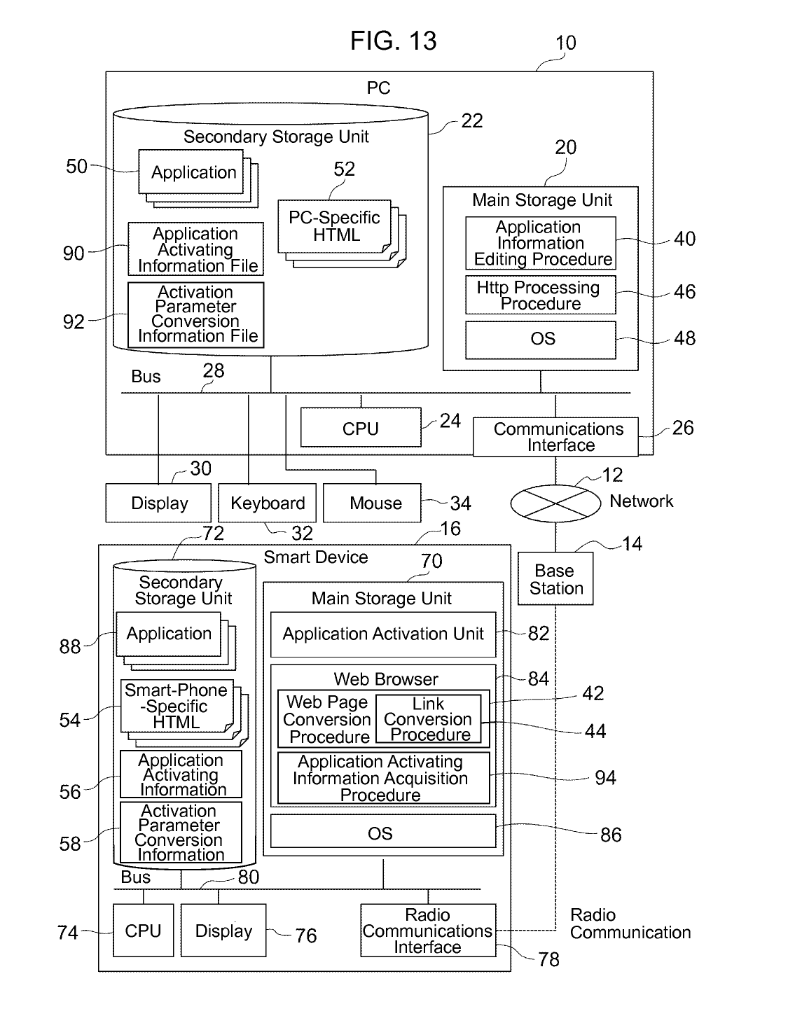

FIG. 13 is a configuration diagram of an information communication system according to a second embodiment of the present invention. This embodiment is configured so that: an application activating information file 90 and an activation parameter conversion information file 92 are stored in the secondary storage unit 22 for the Web server 10 instead of the application activating information 56 and the activation parameter conversion information 58; a smart-device-specific HTML 54, application activating information 56, and activation parameter conversion information 58 are stored in the secondary storage unit 72 for the smart device 16; the Web page conversion procedure 42 and the link conversion procedure 44 are stored in the main storage unit 70 for the smart device 16 instead of the main storage unit 20; and application activating information acquisition procedure 94 is newly stored in the main storage unit 70. Other configurations are the same as those of the first embodiment.

According to this embodiment under this circumstance, the application activating information file 90, which is the application activating information 56 expressed in an XML (Extensible Markup Language) format, is stored in the secondary storage unit 22; the activation parameter conversion information file 92, which is the activation parameter conversion information 58 expressed in the XML format, is stored in the secondary storage unit 22; the application activation file 90 and the activation parameter conversion information file 92 are acquired from the Web server 10 by using the application activating information acquisition procedure 94 of the smart device 16; information of each acquired file is stored as the application activating information 56 or the activation parameter conversion information 58 in the secondary storage unit 72; and Web page conversion processing and link conversion processing are implemented by using the Web page conversion procedure 42 and the link conversion procedure 44 which are located in the smart device 16. In this case, the CPU 74 functions as an information conversion unit for converting information of a PC-specific Web page into information to which the smart device 16 refers. The processing of the Web page conversion procedure 42 and the link conversion procedure 44 is the same as that in the first embodiment. Furthermore, a value of a user-agent header included in an HTTP request is used in the first embodiment, while information about the OS 86 is acquired by using an API (Application Programming Interface) provided by the OS 86 in the second embodiment.

The application activating information file 90 and the activation parameter conversion information file 92 are created by a Web page creator by using the application information editing procedure 40 and are stored with specific file names in the secondary storage unit 22.

For example, the application activating information file 90 is placed with its file name=applicationExecution,xml in the Web server 10 and the activation parameter conversion information file 92 is placed with its file name=parameterConversion,xml in the Web server 10.

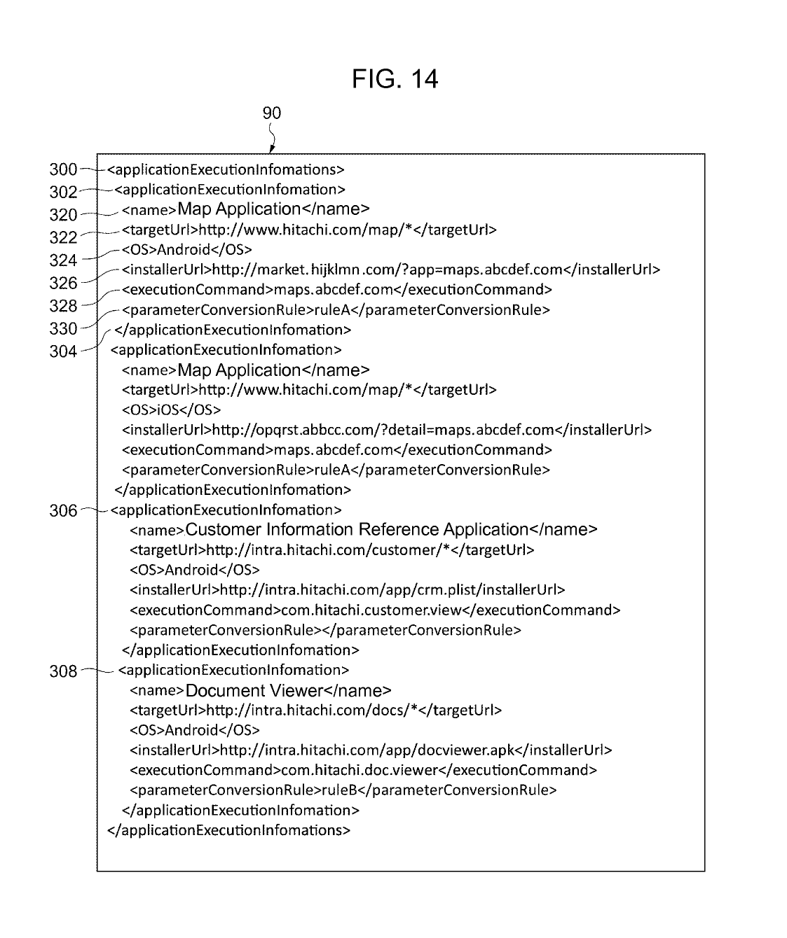

FIG. 14 is a configuration diagram of the application activating information file. Referring to FIG. 14, a tag 300 exists in the application activating information file 90 and the tag 300 includes as many tags 302, 306, 308 as the number of applications. Among these tags 302, 306, 308, for example, the tag 302 includes a tag 320 representing an application name, a tag 322 representing an object URL, a tag 324 representing an OS type, a tag 326 representing an installer URL, a tag 328 representing an activation command, and a tag 330 representing a parameter conversion rule.

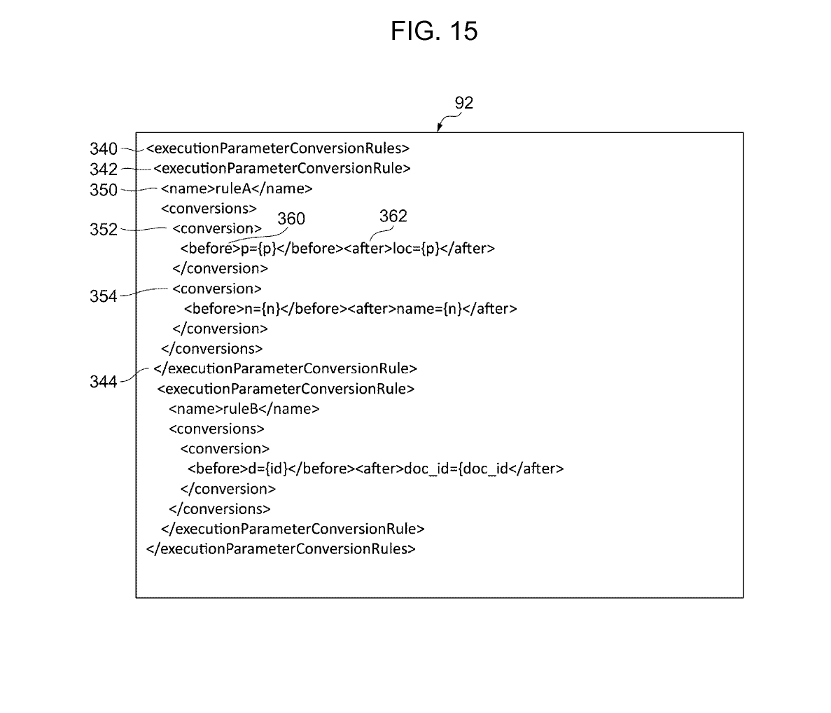

FIG. 15 is a configuration diagram of the activation parameter conversion information file. Referring to FIG. 15, a tag 340 exists in the activation parameter conversion information file 92 and the tag 340 includes as many tags 342 as the number of the parameter conversion rules. For example, the tag 342 includes a tag 350 representing a rule name and also includes as many tags 352, 354, which represent conversion rules, as the number of activation parameters. The tag 352 includes a tag 360 representing the format of a pre-conversion parameter and a tag 362 representing the format of a converted parameter.

Regarding the configuration of the application activation file 90 and the activation parameter conversion information file 92, there is a variation in which the content of these files is embedded in a PC-specific HTML page. In this case, the content of each file can be described in, for example, a tag “<style type=text/app-exec>.” This tag is embedded as a browse tag for specifying the content of the application activating information in a PC-specific Web page.

Furthermore, the application activating information 56 and the activation parameter conversion information 58 are created by a user of the Web page, for example, a user of the smart device 16; and the application activating information 56 and the activation parameter conversion information 58 which are created can be stored in the secondary storage unit 72. In this case, the advantage is that the Web page user can convert a PC-specific Web page into a smart-device-specific Web page responsive to the smart device 16.

According to this embodiment, the link conversion processing can be executed at the smart device 16 by placing the Web page conversion procedure 42 and the link conversion procedure 44 in the smart device 16 without placing the Web page conversion procedure 42 and the link conversion procedure 44 in the Web server 10.

### Third Embodiment

This embodiment is configured to cooperate with an MDM (Mobile Device Management) system for managing the smart device; and when the MDM system centrally manages information about applications and if new versions of the applications are published, the applications can be updated.

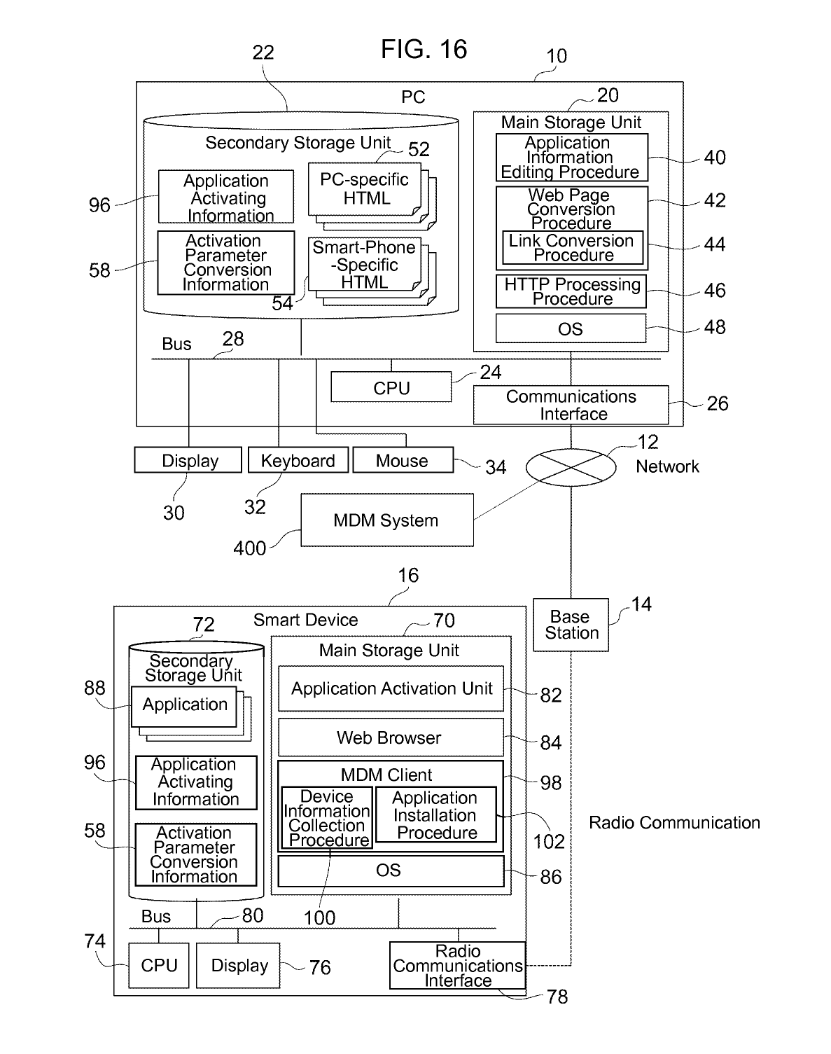

FIG. 16 is a configuration diagram showing an information communication system according to a third embodiment. Referring to FIG. 16, this embodiment is configured so that: an MDM system 400 is connected to the network 12; application activating information 96, instead of the application activating information 56, is stored in the secondary storage unit 22 for the Web server 10; the activation parameter conversion information 58 and the application activating information 96 are stored in the secondary storage unit 72 for the smart device 16; an MDM client 98 is newly stored in the main storage unit 70; and a device information collection procedure 100 and an application installation procedure 102 are stored in the MDM client 9. Other configurations are the same as those in the first embodiment. However, the details of the processing of the Web page conversion procedure 42 and the link conversion procedure 44 are partly different from those in the first embodiment.

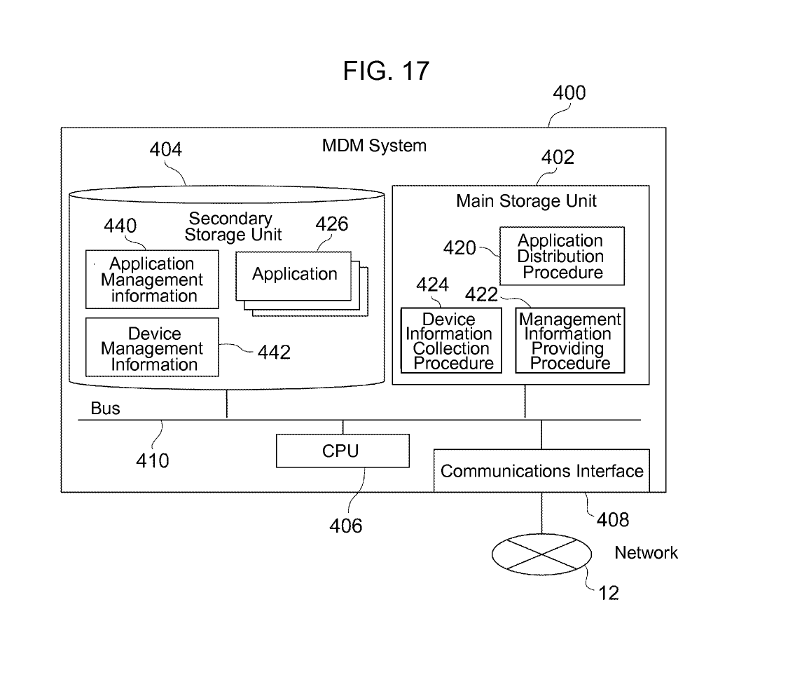

FIG. 17 is a configuration diagram of the MDM system. Referring to FIG. 17, the MDM system 400 is configured as a management device including a main storage unit 402, a secondary storage unit 404, a CPU 406, a communications interface 408, and a bus 410; and the main storage unit 402, the secondary storage unit 404, the CPU 406, and the communications interface 408 are connected with each other via the bus 410.

The CPU 406 functions as a control unit for supervising and controlling the entire MDM system 400 and also functions as a processing unit for executing various processing based on programs or information stored in the main storage unit 402 and the secondary storage unit 404. The communications interface 408 functions as an interface for connecting the CPU 406 to the network 12.

The main storage unit 402 stores an application distribution procedure 420, a management information providing procedure 422, and a device information collection procedure 424 as programs.

The secondary storage unit 404 stores a plurality of applications 426 to be distributed to smart devices 16, application management information 440 for managing the applications 426, and device management information 442 including a list of smart devices 16 and their device information.

The application distribution procedure 420 is activated by the CPU 406, acquires an application 426 in response to an invocation from the application installation procedure 102 of the smart device 16, and installs the acquired application 426, as the application 88, into the secondary storage unit 72 for the smart device 16.

The management information providing procedure 422 is activated by the CPU 406 and provides the application management information 440 and the device management information 442 to various procedures in external systems such as the Web server 10 and the smart device 16.

The device information collection procedure 424 is activated by the CPU 406, collects device information of the smart device 16 via the network 12, and stores the collected device information in the management device information 442. Under this circumstance, the device information collection procedure 100 of the smart device 16 is activated by the CPU 74. The device information collection procedure 100 acquires the device information of the smart device 16 by using the API of the OS 86 and transfers the acquired device information via the network 12 to the device information collection procedure 424 of the MDM system 400.

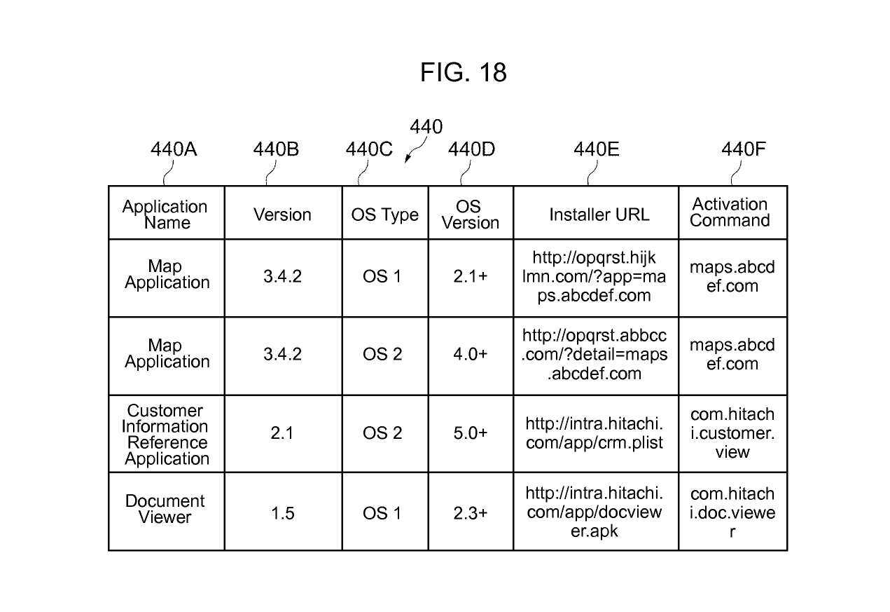

FIG. 18 is a configuration diagram of the application management information. Referring to FIG. 18, the application management information 440 is constituted from an application name 440A, a version 440B, an OS type 440C, an OS version 440D, an installer URL 440E, and an activation command 440F.

The application name 440A is similar to the application name 56A of the application activating information 56 and the version 440B is information for specifying a version of an application registered in the application name 440A. The OS type 440C, the OS version 440D, the installer URL 440E, and the activation command 440F are respectively similar to the OS type 56C, the OS version 56D, the installer URL 56E, and the activation command 56F of the application activating information 56.

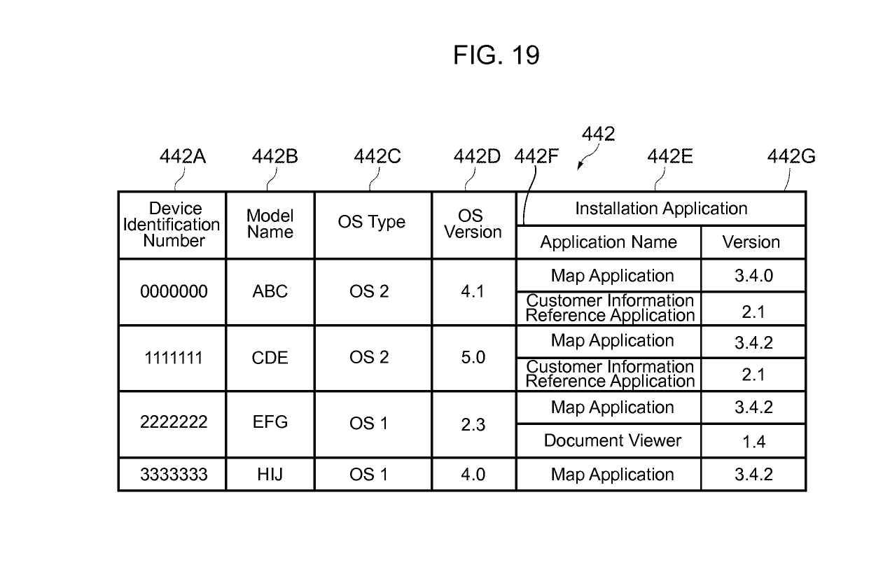

FIG. 19 is a configuration diagram of the device management information. Referring to FIG. 19, the device management information 442 is information registered by a user of the MDM system 400, for example, an administer who manages smart devices 16 by using a company's information system; and the device management information 442 is constituted from a device identification number 442A, a model name 442B, an OS type 442C, an OS version 442D, and an installation application 442E.

The device identification number 442A is the number that uniquely identifies the relevant smart device 16. The model name 442B is information for specifying a model name of the smart device 16. The OS type 442C is information for specifying a type of the OS 86 mounted on the smart device 16. The OS version 442D is information for specifying a version of the OS 86.

The installation application 442E is constituted from an application name 442F and a version 442G. The application name 442F is information for specifying an application name of the application 88 installed in the secondary storage unit 72. The version 442G is information for specifying a version of the application 88 installed in the secondary storage unit 72.

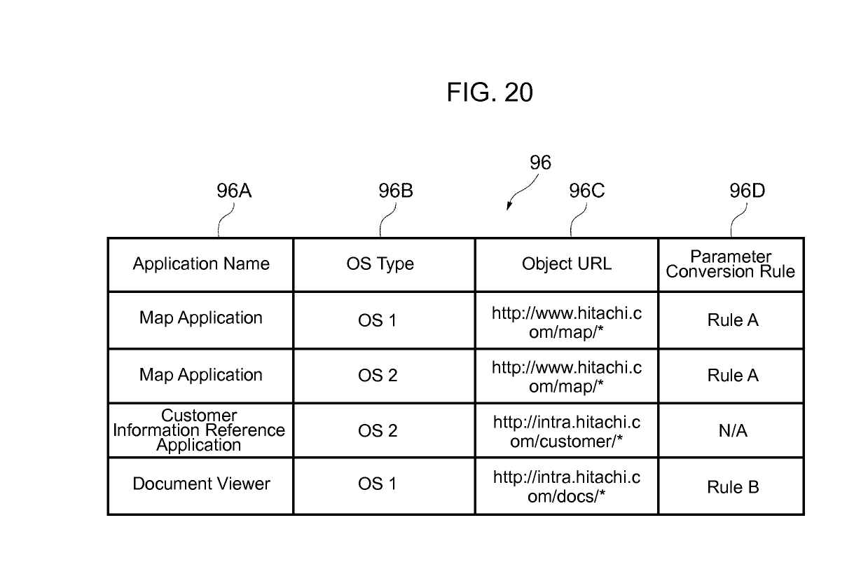

FIG. 20 is a configuration diagram of the application activating information. Referring to FIG. 20, the application activating information 96 is information placed in the Web server 16 and the smart device 16 and is constituted from an application name 96A, an OS type 96B, an object URL 96C, and a parameter conversion rule 96D.

The application name 96A, the OS type 96B, the object URL 96C, and the parameter conversion rule 96D are respectively similar to the application name 56A, the OS type 56C, the object URL 56B, and the parameter conversion rule 56G of the application activating information 56. Specifically speaking, the application activating information 96 has a data structure in which the items of the application management information 440 of the MDM system 400 are deleted from the application activating information 56.

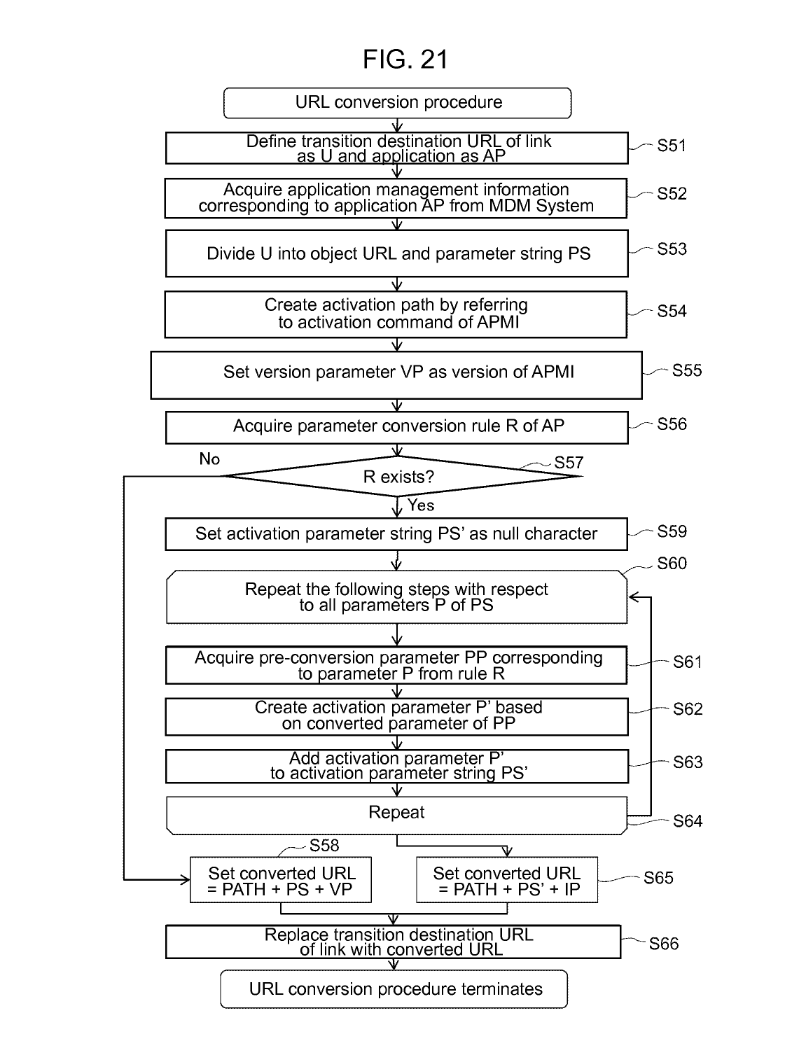

FIG. 21 is a flowchart for explaining the URL conversion procedure. This processing is started by the CPU 24 as it activates a program (not shown) of the URL conversion procedure stored in the main storage unit 20.

The CPU 24 defines a transition destination URL of a link as U and an application as AP (S51).

Next, the CPU 24 acquires application management information (APMI) 440 corresponding to the application AP from the MDM system 400 (S52) and divides U into an object URL and a parameter string PS (S53). For example, the CPU 24 divides the transition destination URL of the link (a href=), which is included in the Web page, into the object URL (/map/) and the parameter string PS (p=35.403 . . . ).

Then, if the CPU 24 selects, for example, “Map Application” as the application AP, it refers to the activation command 440F of the application AP corresponding to “Map Application” in the application management information (APMI) 440 and creates an activation path PATH (=callapp://+activation command+/) (S54).

Subsequently, the CPU 24 refers to the version 440B of the application AP in the application management information 440 and sets a version parameter VP as the version of the application AP (the version registered in the version 440B) (S55).

Next, the CPU 24 refers to the parameter conversion rule 96D of the application AP and acquires a parameter conversion rule R (Rule A) from the parameter conversion rule 96D (S56).

Then, the CPU 24 judges whether the parameter conversion rule R exists in the parameter conversion rule 96D or not (S57).

If the CPU 24 obtains a negative judgment result in step S57, the CPU 24 sets a converted URL=activation path PATH+parameter string PS+installer parameter IP (S58) and proceeds to processing of step S66.

On the other hand, if the CPU 24 obtains an affirmative judgment result in step S57, the CPU 24 sets an initial value of an activation parameter string PS′ by setting the activation parameter string PS′ as a null character (S59).

Next, the CPU 24 repeats processing from step S60 to step S64 on all parameters P for the parameter string PS. The parameter herein used is a parameter registered in the pre-conversion parameter 58B of the activation parameter conversion information 58; and, for example, if “Rule A” is used as the parameter conversion rule 58A, p and n are selected as the pre-conversion parameter 58B. Furthermore, the parameter string is a connection of p and n.

Then, the CPU 24 acquires a pre-conversion parameter PP corresponding to the parameter P from the parameter conversion rule A (S61). For example, the CPU 24 acquires p as the pre-conversion parameter PP from the pre-conversion parameter 58B.

Subsequently, the CPU 24 creates an activation parameter P′ based on the converted parameter 58C of the pre-conversion parameter PP (S62). For example, the CPU 24 selects loc as the activation parameter P′ from the converted parameter 58C.

Next, the CPU 24 adds the created activation parameter P′ to the activation parameter string PS′ (S63).

Subsequently, the CPU 24 repeats the processing from step S60 to step S64, selects n from the pre-conversion parameter 58B, selects name as the activation parameter P′ from the converted parameter 58B, and adds the selected activation parameter P′ to the activation parameter string PS′.

Then, the CPU 24 sets a converted URL=activation path PATH+sign parameter string PS′+installer parameter IP (S65).

Next, the CPU 24 replaces a transition destination URL of a link destination with the converted URL created in step S58 or step S65 (S66), and then terminates the processing in this routine.

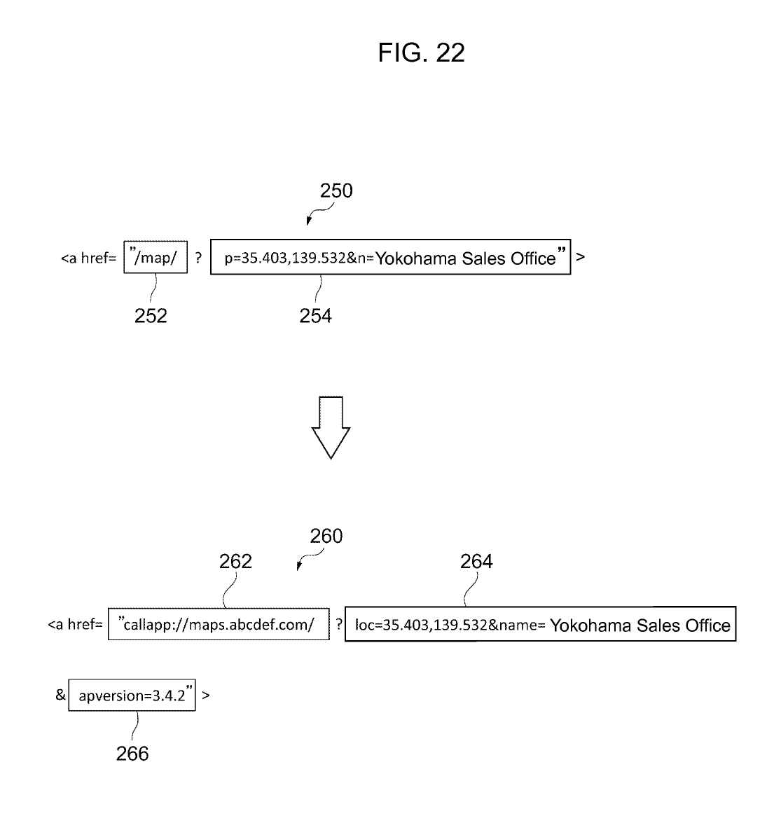

FIG. 22 is a configuration diagram of a link, which is converted by the URL conversion procedure, before and after the conversion. Referring to FIG. 22, a pre-conversion link 250 is composed of an object URL 252 and a parameter string 254. On the other hand, a converted link 260 is constituted from an activation path 262, an activation parameter string 264, and an AP version 266.

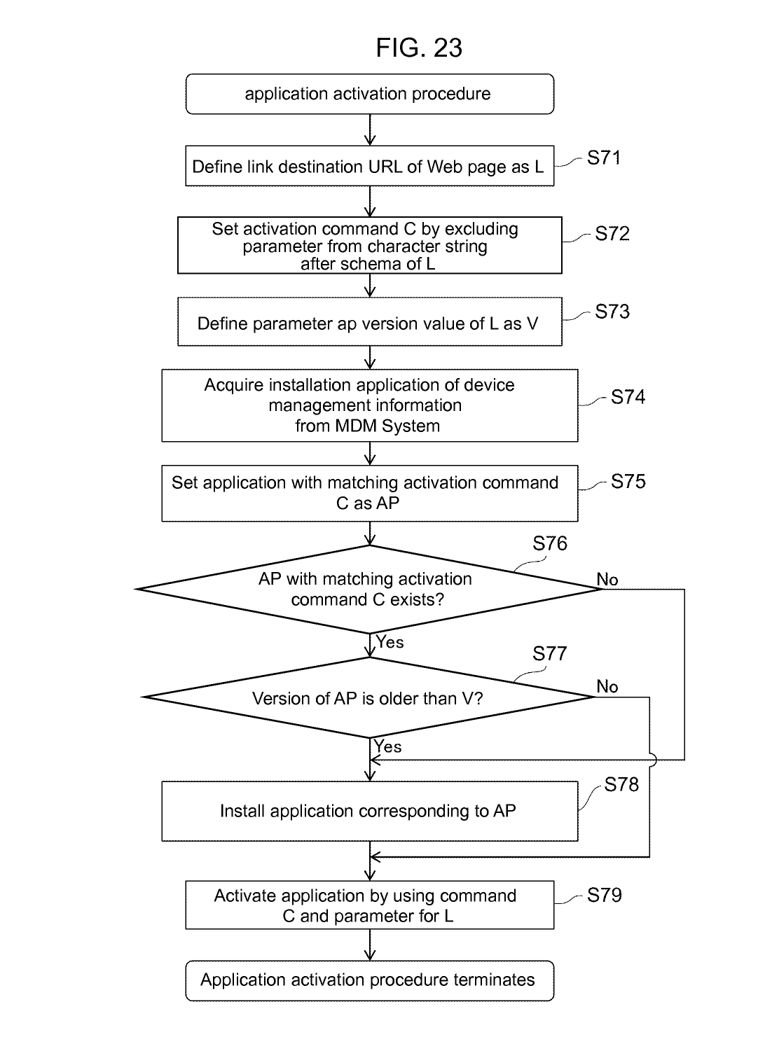

FIG. 23 is a flowchart for explaining the application activation procedure. This processing is started by the CPU 74 as it activates a program (not shown) indicating the application activation procedure stored in the main storage unit 70. This processing is to activate the application 88 by using the activation command included in the activation path of URL. Under this circumstance, if the version of that application 88 is older than the version designated by the AP version 266, the application 88 acquired from the MDM system 400 is installed.

Specifically speaking, the CPU 74 defines the link destination URL of the Web page as L (S71), sets an activation command C by excluding the parameter from the character string after the schema of L (S72), and sets the value of the parameter (AP version) for L as version V (the version registered in the version 440B) (S73).

Next, the CPU 74 acquires applications registered in the installation application 442E of the device management information 442 corresponding to the smart device 16, in which the application activation procedure is being executed, from the MDM system 400 (S74).

Then, the CPU 74 selects an application with the matching activation command C from among the applications registered in the installation application 442E and sets the selected application as AP (S75).

Subsequently, the CPU 74 judges whether any application AP with the matching activation command C exists or not (S76).

If the CPU 24 obtains a negative judgment result in step S76, the CPU 74 proceeds to processing of step S78; and if the CPU 24 obtains an affirmative judgment result in step S76, it judges whether the version of the application AP (the version registered in the version 442G) is older than the AP version V (the version registered in the version 440B) or not (S77).

Then, if the CPU 24 obtains a negative judgment result in step S77, the CPU 74 proceeds to processing of step S79; and if the CPU 24 obtains an affirmative judgment result in step S77, the CPU 24 activates the application installation procedure 102 in the MDM client 98 and installs an application corresponding to the application AP as the application 88 into the secondary storage unit 72 (S78).

Next, the CPU 74 activates an application which had been installed, or the installed application 88 by using the command C and the parameter for L (however, excluding the AP version) and then terminates the processing in this routine.

According to this embodiment, when the MDM system 400 centrally manages information about the application 88 and discloses a new version of the application, it is possible to update the old version application 88.

Incidentally, the present invention is not limited to the aforementioned embodiments, and includes various variations. For example, the aforementioned embodiments have been described in detail in order to explain the invention in an easily comprehensible manner and are not necessarily limited to those having all the configurations explained above. Furthermore, part of the configuration of a certain embodiment can be replaced with the configuration of another embodiment and the configuration of another embodiment can be added to the configuration of a certain embodiment. Also, part of the configuration of each embodiment can be deleted, or added to, or replaced with, the configuration of another configuration.

Furthermore, part or all of each of the aforementioned configurations, functions, processing units, processing means, and so on may be realized by hardware by, for example, designing them in integrated circuits. Also, each of the aforementioned configurations, functions, and so on may be realized by software by processors interpreting and executing programs for realizing each of the functions. Information such as programs, tables, and files for realizing each of the functions may be recorded and retained in memories, storage devices such as hard disks and SSDs (Solid State Drives), or storage media such as IC (Integrated Circuit) cards, SD (Secure Digital) memory cards, and DVDs (Digital Versatile Discs).

### REFERENCE SIGNS LIST

10 Web server; 12 network; 14 base station; 16 smart device; 20 main storage unit; 22 secondary storage unit; 24 CPU; 40 application information editing procedure; 42 Web page conversion procedure; 44 link conversion procedure; 46 HTTP processing procedure; 48 OS; 50 application; 52 PC-specific HTML; 54 smart-device-specific HTML; 56 application activating information; 58 activation parameter conversion information; 70 main storage unit; 72 secondary storage unit; 74 CPU; 82 application activation unit; 84 Web browser; 86 OS; 88 application; 90 application activating information file; 92 activation parameter conversion information file; 94 application activating information acquisition procedure; 96 application activating information; 100 device information collection procedure; 102 application installation procedure; 420 application distribution procedure; 422 management information providing procedure; 424 device information collection procedure; 440 application management information; and 442 device management information.

1. An information communication system comprising:
a Web server connected to a network;
a smart device for sending and receiving information to and from the Web server via the network;
an information conversion unit, which is located at either the Web server or the smart device, for converting information of a PC-specific Web page managed by the Web server into information of a smart-device-specific Web page to which the smart device refers;
wherein the information conversion unit retains application activating information, which manages a transition destination of a first link included in the PC-specific Web page and a smart-device-specific application by associating them with each other and includes reference information used when activating the smart-device-specific application; when receiving a conversion request from the smart device, the information conversion unit refers to the application activating information based on the transition destination of the first link included in the PC-specific Web page and specifies a smart-device-specific application which matches the transition destination of the first link; and on condition that an operating system and version of the smart-device-specific application match an operating system and version of the smart device, the information conversion unit executes link conversion processing for converting the first link into a second link including an activation path in the application activating information and converting information of the converted second link into information of a language for the smart device; and
wherein the smart device displays the second link, which has been converted by the information conversion unit, on the smart-device-specific Web page.

2. The information communication system according to claim 1, wherein when a parameter string exists in the first link and a parameter conversion rule is defined in the application activating information, the information conversion unit converts the parameter string included in the first link into an activation parameter string in accordance with the parameter conversion rule and converts information of the second link including the converted activation parameter string and the activation path into the information of the language for the smart device; and
wherein when the smart-device-specific application exists in the smart device, the smart device activates the smart-device-specific application based on an activation command, which includes the activation path and the activation parameter string of the second link converted into the information of the language for the smart device, in response to operation on the displayed second link.

3. The information communication system according to claim 1, wherein when a parameter string exists in the first link, a parameter conversion rule is defined in the application activating information, and an installer URL is defined in the application activating information, the information conversion unit converts the parameter string included in the first link into an activation parameter string in accordance with the parameter conversion rule and converts information of the second link, which includes the activation path, the converted activation parameter string, and the installer URL, into the information of the language for the smart device; and
wherein when the smart-device-specific application does not exist in the smart device, the smart device acquires the smart-device-specific application via the network based on the installer URL included in the second link, which is converted into the language for the smart device, and activates the acquired smart-device-specific application based on an activation command including the activation path.

4. The information communication system according to claim 1, wherein when an embedded object exists in the first link, the information conversion unit converts the embedded object into a display tag which becomes an operation object for activating the smart-device-specific application and converts information of the second link including the converted display tag and the converted activation path into the information of the language for the smart device; and
wherein when the smart device displays the display tag of the second link, which is converted into the language for the smart device, in the smart-device-specific Web page and the smart-device-specific application exists in the smart device, the smart device activates the smart-device-specific application based on an activation command including the activation path of the information of the second link, which is converted into the language for the smart device, in response to operation on the display tag of the displayed second link.

5. The information communication system according to claim 1, wherein the Web server has the information conversion unit and the application activating information; and
wherein the information conversion unit located in the Web server executes the link conversion processing, converts the information of the second link acquired by the link conversion processing into the information of the language for the smart device and sends the information of the converted second link to the smart device.

6. The information communication system according to claim 1, wherein the Web server retains the application activating information;
the smart device has the information conversion unit; and
the information conversion unit for the smart device acquires the application activating information from the Web server and executes the link conversion processing based on the acquired application activating information.

7. The information communication system according to claim 1, wherein a browse tag for specifying the content of the application activating information is embedded in the PC-specific Web page.

8. The information communication system according to claim 1, further comprising a management device for: retaining device management information about an installation application installed in the smart device and application management information, which manages the smart-device-specific application and a version of that application by associating them with each other and includes reference information used when activating the smart-device-specific application; and sending and receiving information to and from the smart device and the Web server via the network;
wherein when executing the link conversion processing, the information conversion unit acquires the application management information from the management device, converts the first link into a second link including the converted activation path and a version parameter indicative of a version, which is recorded in the application management information and is a version of the smart-device-specific application, and converts information of the converted second link into the information of the language for the smart device; and
wherein the smart device acquires the device management information from the management device in response to operation on the displayed second link and judges, based on an activation command including the activation path of the second link, which is converted into the language for the smart device, whether an application matching the activation command exists in the device management information or not; on condition that the smart device obtains an affirmative result for the judgment, it acquires the application management information from the management device and judges whether or not a version of the application which matches the activation command and is recorded in the application management information is older than the version defined by the version parameter included in the second link, which is converted into the language for the smart device; if the smart device obtains an affirmative result for the judgment of the version and finds that the version recorded in the application management information is older, it installs an application, which matches the version defined by the version parameter included in the second link, as the smart-device-specific application from the management device and activates the installed smart-device-specific application in accordance with the activation command; and if the smart device obtains a negative result for the judgment of the version and finds that the version recorded in the application management information is not older, it activates the application matching the activation command as the smart-device-specific application in accordance with the activation command.

9. An information conversion method for an information communication system including:
a Web server connected to a network;
a smart device for sending and receiving information to and from the Web server via the network;
an information conversion unit, which is located at either the Web server or the smart device, for converting information of a PC-specific Web page managed by the Web server into information of a smart-device-specific Web page to which the smart device refers;
wherein the information conversion unit executes:
a step of retaining application activating information, which manages a transition destination of a first link included in the PC-specific Web page and a smart-device-specific application by associating them with each other and includes reference information used when activating the smart-device-specific application;
a step, which is executed when receiving a conversion request from the smart device, of referring to the application activating information based on the transition destination of the first link included in the PC-specific Web page and specifying a smart-device-specific application which matches the transition destination of the first link; and
a step, which is executed on condition that an operating system and version of the specified smart-device-specific application match an operating system and version of the smart device, of executing link conversion processing for converting the first link into a second link including an activation path in the application activating information; and
a step of converting information of the converted second link into information of a language for the smart device; and
wherein the smart device executes a step of displaying the second link, which has been converted by the information conversion unit, on the smart-device-specific Web page.

10. The information conversion method according to claim 9, wherein when a parameter string exists in the first link and a parameter conversion rule is defined in the application activating information, the information conversion unit executes:
a step of converting the parameter string included in the first link into an activation parameter string in accordance with the parameter conversion rule; and
a step of converting information of the second link including the converted activation parameter string and the activation path into the information of the language for the smart device; and
wherein when the smart-device-specific application exists in the smart device, the smart device executes a step of activating the smart-device-specific application based on an activation command, which includes the activation path and the activation parameter string of the second link converted into the information of the language for the smart device, in response to operation on the displayed second link.

11. The information conversion method according to claim 9, wherein when a parameter string exists in the first link, a parameter conversion rule is defined in the application activating information, and an installer URL is defined in the application activating information, the information conversion unit executes:
a step of converting the parameter string included in the first link into an activation parameter string in accordance with the parameter conversion rule; and
a step of converting information of the second link, which includes the activation path, the converted activation parameter string, and the installer URL, into the information of the language for the smart device; and
wherein when the smart-device-specific application does not exist in the smart device, the smart device executes:
a step of acquiring the smart-device-specific application via the network based on the installer URL included in the second link, which is converted into the language for the smart device; and
a step of activating the acquired smart-device-specific application based on an activation command including the activation path.

12. The information conversion method according to claim 9, wherein when an embedded object exists in the first link, the information conversion unit executes:
a step of converting the embedded object into a display tag which becomes an operation object for activating the smart-device-specific application; and
a step of converting information of the second link including the converted display tag and the converted activation path into the information of the language for the smart device; and
wherein the smart device executes:
a step of displaying the display tag of the second link, which is converted into the language for the smart device, in the smart-device-specific Web page; and
a step, which is executed when the smart-device-specific application exists in the smart device, of activating the smart-device-specific application based on an activation command including the activation path of the information of the second link, which is converted into the language for the smart device, in response to operation on the display tag of the displayed second link.

13. The information conversion method according to claim 9, wherein the Web server has the information conversion unit and the application activating information; and
wherein the information conversion unit located in the Web server executes:
a step of executing the link conversion processing and converting the information of the second link acquired by the link conversion processing into the information of the language for the smart device; and
a step of sending the information of the converted second link to the smart device.

14. The information conversion method according to claim 9, wherein the Web server executes a step of retaining the application activating information;
wherein the smart device has the information conversion unit; and
wherein the information conversion unit for the smart device executes:
a step of acquiring the application activating information from the Web server; and
a step of executing the link conversion processing based on the acquired application activating information.

15. The information conversion method according to claim 9, wherein the information conversion system includes a management device for: retaining device management information about an installation application installed in the smart device and application management information, which manages the smart-device-specific application and a version of that application by associating them with each other and includes reference information used when activating the smart-device-specific application; and sending and receiving information to and from the smart device and the Web server via the network;
wherein the information conversion unit executes:
a step of acquiring the application management information from the management device when executing the link conversion processing;
a step of converting the first link into a second link including the converted activation path and a version parameter indicative of a version, which is recorded in the application management information and is a version of the smart-device-specific application; and
a step of converting information of the converted second link into the information of the language for the smart device; and
wherein the smart device executes:
a step of acquiring the device management information from the management device in response to operation on the displayed second link;
a step of judging, based on an activation command including the activation path of the second link, which is converted into the language for the smart device, whether an application matching the activation command exists in the device management information or not;
a step, which is executed on condition that the smart device obtains an affirmative result for the judgment, of acquiring the application management information from the management device and judging whether or not a version of the application which matches the activation command and is recorded in the application management information is older than the version defined by the version parameter included in the second link, which is converted into the language for the smart device;
a step, which is executed if the smart device obtains an affirmative result for the judgment of the version and finds that the version recorded in the application management information is older, of installing an application, which matches the version defined by the version parameter included in the second link, as the smart-device-specific application from the management device;
a step of activating the installed smart-device-specific application in accordance with the activation command; and
a step, which is executed if the smart device obtains a negative result for the judgment of the version and finds that the version recorded in the application management information is not older, of activating the application matching the activation command as the smart-device-specific application in accordance with the activation command.
